(19) United States
(12) Patent Application Publication
(10) Pub. No.: US 2007/0289180 A1
(43) Pub. Date: Dec. 20, 2007

(54) Light box

(76) Inventor: Jeff Johnson, Citrus Heights, CA (US)

Correspondence Address: HOLME ROBERTS & OWEN, LLP, 299 SOUTH MAIN, SUITE 1800, SALT LAKE CITY, UT, 84111, US

(21) Appl. No.: 11/442,775

(22) Filed: May 30, 2006

(51) Int. Cl. G09F 13/18

(52) U.S. Cl. 40/546

(57) ABSTRACT

An edge-lit light box provides an attractive display by directing light through an image area on a light box. The light box includes a light box frame having at least one light source connected to the interior thereof. An opaque backing is attached to a first side the frame. A display member is attached to a second side of the frame opposite the backing, the display screen preferably being a transparent or translucent substrate having an opaque area and an image area, whereby light emitted by the light source emits into a void between the backing and the display member and light exits the light box through the image area such that a viewer sees an illuminated image defined by the image area.

### BACKGROUND OF THE INVENTION

1. The Field of the Invention

The present invention relates to the field of illuminated image displays. More particularly, the invention relates to edge-lit display boxes that provide a back lighting effect for and through an image with translucent portions.

2. The Relevant Technology

Displays such as picture frames, posters, and directional signs are used in decorating and communicating information, among other things. One type of display includes illuminated back-lit and edge-lit light boxes that use lighting to enhance the visibility of the content in a translucent poster display. Typical examples of light boxes are the back-lit and edge-lit posters used for advertising to draw a customer's attention to the advertisement. See U.S. Pat. No. 5,680,720. These light boxes can be formed, for example, with a translucent poster, alone or laminated to a transparent substrate, that is placed in front of a light source. The edge or back lighting then illuminates the entire poster from behind so it is attention grabbing and more visible.

Illuminated displays are also used in informative signs such as “EXIT” signs. These signs can be structured so a viewer only sees illuminated selected parts of the front display, e.g. the letters forming the word “EXIT.” The front display portions of these signs can be formed, for example, by cutting out portions of a metal sheet to form the desired characters or by coating with opaque materials to form the desired characters. See U.S. Pat. No. 5,365,411, incorporated herein by reference. Exit signs are known that use light emitting diodes (LEDs) to effect good illumination of the displays with a reduced power requirement (an array may require only 2 watts) and longer light source life. See U.S. Pat. No. 5,365,411.

Still, new and improved light boxes and illuminated displays are desirable, particularly ones that are suitable for interior and decorative displays.

### BRIEF SUMMARY OF THE INVENTION

The present invention is an edge-lit display having on its display surface both a translucent or transparent section through which a viewer can see light and an opaque section through which a viewer cannot see light. Hence, when illuminated the shape and expanse of the translucent or transparent section, and hence the visible light, define an illuminated shape such that a viewer can perceive an illuminated image.

The display is thin, using a thin light box frame, connected to the periphery of the display, to which light sources are attached on an interior surface thereof. The frame has a backing connected on one side and a display member connected on an opposing side. Hence, the light box forms a relative light seal such that light emitted by the light sources is only visible by a viewer through the translucent or transparent section. In operation, the light is emitted by the light sources into a void between the display surface and the opposing opaque backing and is scattered or diffused such that a viewer can see light through the translucent or transparent section and perceive the illuminated image.

The lighted displays can be used in creating attractive displays for home decorating, for example providing images of landscapes, building, persons, and the like. Such images can be etched, preferably laser etched, into a suitable opaque film to create the display surface. The invention can adapted for use in advertising, traffic signs, directional signs, as lighted displays on vehicles, and the like.

Accordingly, a first example embodiment of the invention is an edge-lit light box. The box generally includes: a light box frame having opposing first and second sides and an inside surface; an opaque backing connected to the first side of the frame; a display member connected to the second side of the frame such that a void is formed between the backing and the display member, the display member comprising an opaque region and a non-opaque region; and at least one light source connected to the interior surface of the light box frame such that operation of the light source emits light into the void between the backing and the display screen and scattered light exits the light box through the non-opaque region of the display member such that a viewer sees an illuminated image defined by the non-opaque region.

Another example embodiment of the invention is also an edge-lit light box. This light box includes a light box frame having opposing first and second sides and an inside surface. An opaque backing is connected to the first side of the frame. A display substrate is connected to the second side of the frame and opposite the backing such that a void is formed between the backing and the display substrate, the display substrate having an opaque film formed thereon with a laser etched image formed in the film such that a non-opaque image area is defined in the regions of the substrate where the opaque film is absent. At least one LED is connected to the interior surface of the light box frame such that operation of the light source emits light source emits into the void between the backing and the display screen. An optional diffuser is proximate the light source and configured to diffuse light across the non-opaque region such that scattered light exits the light box through the image area such that a viewer can see a desired illuminated image at the image area.

Yet another example embodiment of the invention is a method for forming an illuminated display. The method generally includes forming a display member by forming an opaque film on a transparent substrate and removing portions of the film to create a patterned image in the film. The method also includes: providing a light box frame having opposing first and second sides and one or more inside surfaces; attaching one or more light emitting diodes (LEDs) to the inside surface(s) of the frame; attaching an opaque backing to the first side of the frame; and attaching the display member to the second side of the frame such that the light box frame, the backing and the display member define a void in the interior of the light box, at least some of the light emitted by the LEDs entering the void and directly, by scattering, or through diffusion reaching the patterned image such that a user observing the illuminated display perceives an illuminated imaged defined by the patterned image.

The method generally includes: providing a light box frame and attaching one or more light emitting diodes (LEDs) to inside surfaces of the frame; attaching an opaque backing to a first side of the frame; providing a display screen; and attaching the display screen to a second side of the frame such that the light box frame, the backing and the display screen define an interior of the light box, the light emitted by the LEDs exiting from the interior of the light box through the patterned image in the film. The display screen is formed by: providing an opaque film on a transparent substrate; and removing portions of the film to create a patterned image in the film. The patterned image is preferably formed by laser etching, although other techniques can be used.

These and other objects and features of the present invention will become more fully apparent from the following description and appended claims, or may be learned by the practice of the invention as set forth hereinafter.

### BRIEF DESCRIPTION OF THE DRAWINGS

The following drawings illustrate what are presently believed to be preferred embodiments of the invention. It is appreciated that these drawings depict only typical embodiments of the invention and are therefore not to be considered limiting of its scope. In the drawings:

FIG. 1 illustrates an edge-lit image in a display frame according to an embodiment of the invention,

FIG. 2 illustrates a light box without a display frame according to another embodiment of the invention,

FIG. 3 illustrates a side view of a light box taken along sectional line “A” of FIG. 2 according to another embodiment of the invention,

FIG. 4 illustrates a side view of a light box taken along sectional line “B” of FIG. 2 according to another embodiment of the invention, and

FIG. 5 illustrates a front view of a light box without the display screen attached to show the interior of the light box according to another embodiment of the invention.

### DETAILED DESCRIPTION OF THE PREFERRED EMBODIMENTS

The present invention includes a thin display with a back lighting effect for a transparent image on an otherwise opaque substrate. The display is generally formed with a light box frame having an opaque backing connected to a first side of the frame and a display member connected to the second side of the frame. One or more light sources, such as light emitting diodes, are attached to an inside surface of the frame. Light emitted from the light source(s) enters a void formed between the backing and the display member and direct, diffused, or scattered light exits the light box through the image such that a viewer sees the illuminated image as defined by opaque regions of the display surrounding the transparent image. The display can be made extremely thin by using the one or more light sources in a linear array on an inside perimeter of the or light box frame while effecting light scattering and diffusion to help direct the light through the image.

The illuminated displays have been found to be particularly useful in creating attractive eye-catching displays for interior design. For example, images of landscapes, building, persons, and the like, as well as lettering and other abstract shapes, can be etched into a film and presented as an edge-lit display. The usefulness of the invention goes beyond such displays, however, and can be used for advertising, traffic signs, directional signs, and the like. For example, the inventive light boxes can be mounted on a vehicle for advertising.

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of light sources and systems, light boxes, and picture frames have not been described in particular detail in order to avoid unnecessarily obscuring the present invention.

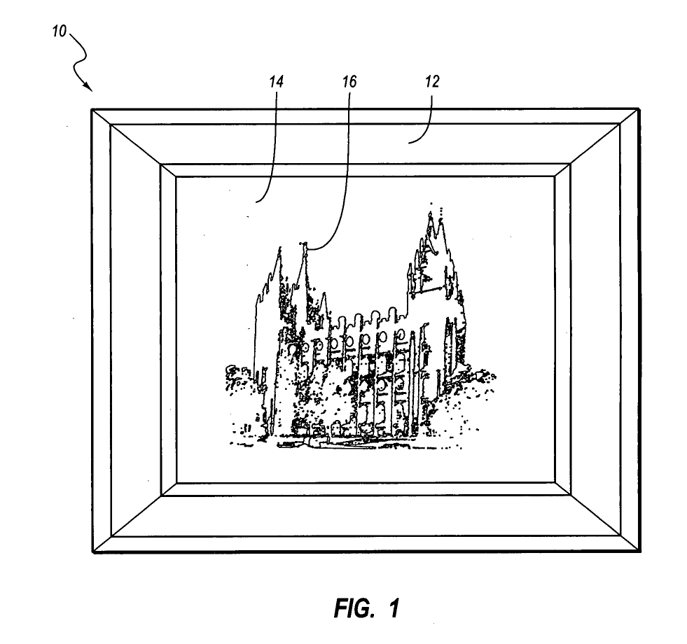

With reference to FIG. 1, an illuminated display 10, or light box, shows a display screen 14 mounted in a display frame 12. The display screen 14 has an image 16 formed thereon that is visible by the light projecting there through. The term “light box” as used herein refers to an internally illuminated container that uses indirectly placed light sources to illuminate the display screen 14, particularly image 16. More particularly, the illuminated display 14 can be described as an edge-lit light box because the light sources illuminating the image 16 are not directly behind the image. In the depicted embodiment the display screen includes an opaque region and a non-opaque to define the image. Unlike conventional illuminated displays that light the entire display screen, the inventive display is opaque in areas that are not the image 16, resulting in light projecting solely through the image 16 to define the image.

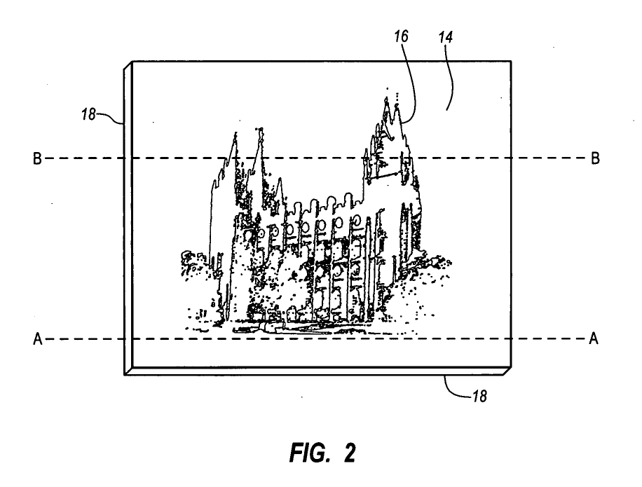

With reference now to FIGS. 2-4, the display screen 14 is preferably attached to a light box frame 18 that is distinct from display frame 12. In other embodiments frame 12 can be integrally formed with light box frame 18, however. Display screen 14 is preferably mounted on light box frame 18 such that a light seal is formed.

In preferred embodiments of the invention the display screen 14 is substantially rectangular in shape, although this is of course not required. Shapes such as circular, oval, and the like or irregularly shaped, or as otherwise used in the fields of picture frames and light boxes, can also be used. The light box frame is preferably, though not necessarily, a similar size to the display screen, and can therefore also be rectangular, circular, oval, and the like or irregularly shaped. In a preferred embodiment, the frame forms a rectangle with two sets of opposing parallel arms attached at the respective ends of connecting perpendicular arms. One or more light arrays, underlying mounts such as printed circuit boards, or individual light sources are mounted to interior surfaces of the frame. The light box frame may therefore be smaller than the display screen to move light sources closer to the image 16.

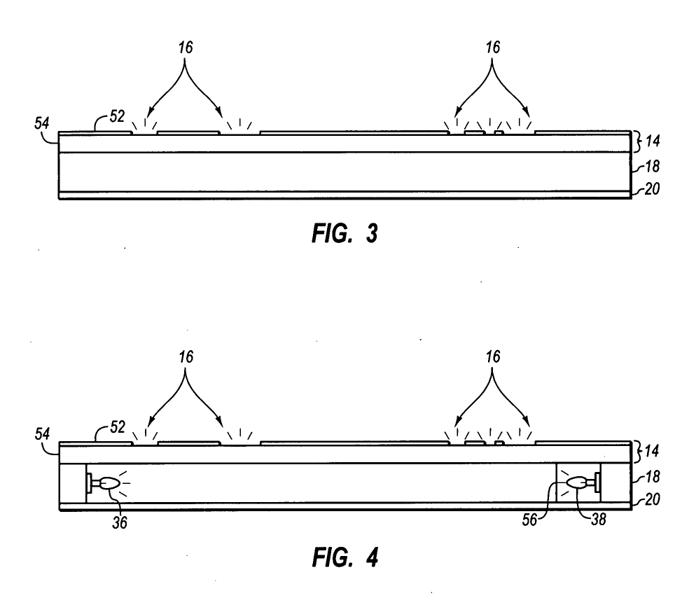

With reference to FIGS. 3-5, an opaque backing 20 is attached to the side of light box frame 18 opposite display screen 14. With light box frame 18 being opaque, and the surfaces of display screen 14 not defining the image 16 being opaque, the only exit for light from enclosed light box 15 is through image 16.

The opaque backing 20 can be formed of a variety of materials, for example plastic, wood, and cardboard. In one embodiment of the invention, the light box frame and backing are an integral part, for example a single piece of molded plastic. Regardless of the material and construction, however, the backing preferably has a light color to increase light reflectance, maximize the light output, and provide a more even output. For example, the backing 20 can be painted with a flat white paint. Other interior surfaces of the light box, for example the interior edge of the light box frame, are also preferably light colored, preferably flat white. An appropriate selection of paint or other surface coating will help diffuse and redirect the light out of the light box evenly.

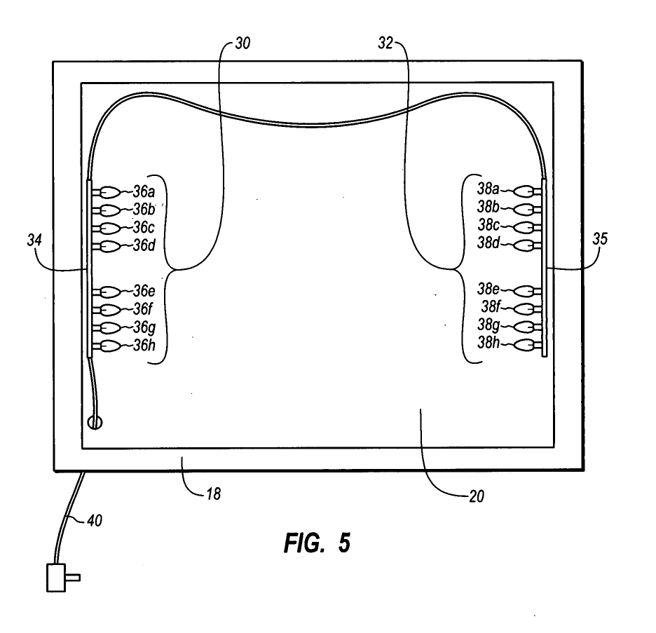

FIG. 5 is a front view of opaque backing 20 and light box frame 18 without the display screen. A pair of light source arrays 30, 32 consisting of light sources 36a-36n and 38a-38n are depicted as attached to a pair of light source frames 34, 35, for example printed circuit boards, which are in turn attached to the light box frame 18. The light source frames 34, 35 can be omitted where the light sources are mounted directly to the light box frame 18 and the appropriate circuitry is otherwise provided. In addition, any number of light source arrays can be used as desired to provide optimum lighting, including zero in the event the light sources are individually configured on the light box frame 18. By way of example of the number of light sources that are preferably used, a 12″ by 16″ image display may be suitable lighted by about 20 typical LEDs.

The ideal positioning of the arrays or individual light sources will depend on the shape of the image. For example, a long image may have a series of light sources on opposing side of the light box lengthwise with the image. A symmetrical image may have an even number of light sources on each side of the light box. The proper arrangement of light sources will be apparent to those of skill in the art in view of the disclosure herein.

Light sources 36, 38 are preferably light emitting diodes (LEDs) due to their relatively high light output to heat and size requirements. More preferably, the light sources are ultra bright LEDs. Preferred LEDs will have a luminous intensity of at least about 8000 mcd. Various features of conventional light sources can also be combined with the invention, for example LEDs that can be selectively energized to emit light at different colors. Other light sources of suitable size and light output can also be used in various embodiments of the invention.

A power cord 40 is illustrated for providing power to the light source arrays 30, 32. Alternatively, battery power or other known power sources can also be used in the event the power requirements are such that batteries may be suitable. For example, where the light box is mounted on a vehicle the power cord can be connected to a power source on the vehicle.

Display screen 14 and/or light box frame 18 can be mounted to frame 12 by any of various means known in the art, for example with screws, nails, brackets, glue, and the like. Alternatively, the entire light box 15 and frame 12 structure can be formed integrally such that mounting the display screen 14 and/or light box frame 18 to the frame 12 is performed independent of forming a light box 15 structure.

Referring to FIGS. 3 and 4, the light box frame 18 forms an opaque ring that has a small depth, for example less than about ¼.″ A thin opaque backing 20, for example less than about 1/16″, is also used. Where the display screen 14 preferably has a thickness of less than about 3/32″, the entire light box 15 in this embodiment preferably has a thickness of less than about ½″.

Backing 20 and/or screen 14 can optionally be inserted into recessed sections (not illustrated) of light box frame 18 such that the entire thickness is limited to the thickness of the light box frame 18. Preferably, light boxes in various embodiments of the invention maintain a thickness of less than about 1″, more preferably less than about ¾″, still more preferably less than abut ½″, still more preferably less than about ¼″. The thickness of the light is substantially limited by the thickness of the light sources 36, 38. The backing and the light box frame can also be monolithically formed, for example as injection molded plastic.

With reference to FIGS. 3 and 4, the display screen 14 includes a preferably opaque film 52 formed on a substrate 54. The display screen 14 is formed by first applying a thin film 52 to a glass substrate 54. An image 16 is then formed by etching, or burning, a desired image in the film by removing selecting portions of the film. Thus, regions of the display screen where the film are removed become transparent or translucent while areas where the film remain are opaque. When the substrate 54 with the image 16 is then inserted on the front of the light box 15 and light sources 36, 38 turned are activated, light is transmitted from the light sources 36, 38, through the space between the backing 20 and the display screen 14, and out through the image formed in the thin film to create an enhanced display image.

Although the embodiments illustrated in FIGS. 3 and 4 depict the film 52 formed on an outer surface of the substrate 54, it will be understood that the etched film can also be applied and formed in an inside surface of the substrate 54, i.e. on an interior surface of the light box and facing backing 20 as opposed to on an exterior surface of the light box.

In various embodiments, the etching process can etch into the transparent substrate, in this case preferably glass, so that micro etches are formed in the glass to scatter the light and thereby enhance the lighting effects.

The substrate is preferably transparent glass, although other transparent materials such as plastic can be used. It may also be preferable to use to tinted glass in some embodiments for effect.

The thin film can be any film suitable for etching and forming a stable high resolution image. Non limiting examples include colored vinyl, paint, tape, and die. The image in the film is preferably formed by laser etching, although other etching techniques, such as photolithography or hand etching, can be used. In some cases the film may not be 100% opaque some illumination appears through the film.

In another embodiment of the invention a diffuser 56 is placed over the light sources to spread or disperse the light so it is less direct or coherent. The diffuser is preferably plastic but other materials may be suitable. The effect of the diffuser is to increase the light visible through the image through light scattering and also to spread light evenly throughout the light box so that certain areas of the image are not unintentionally brighter than others.

With reference to FIG. 3, in operation light is projected by light sources 36, 38 into the space defined by the light box frame 18, display screen 14, and backing 20. Although the light sources preferably emit light over a range of directions, diffuser 56 and surface roughness in internal surfaces, for example the inherent roughness in flat white paint or the roughness in the underlying backing, help redirect and even the light such that it emanates through the opening in the film 52 that define the desired image 16.

In another embodiment of the invention, an image can be placed inside the light box against the white backing that so that is visible through the illuminated engraved image. The image can thereby enhance the display as it is viewable to different amounts at different regions of the display and the amount that is visible changes at different angles of view. Also, colored films or layers can be added to the backing or against the display screen to provide general color enhancements or add detail to the image.

As used in the claims, the term “connect,” “connectable,” or “connected to” are not necessarily limited to a direct connection. The context is useful in determining the intent.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An edge-lit light box, comprising:
a light box frame having opposing first and second sides and an inside surface;
an opaque backing connected to the first side of the frame;
a display member connected to the second side of the frame such that a void is formed between the backing and the display member, the display member comprising an opaque region and a non-opaque region; and
at least one light source connected to the interior surface of the light box frame such that operation of the light source emits light into the void between the backing and the display screen and light exits the light box through the non-opaque region of the display member such that a viewer sees an illuminated image defined by the non-opaque region.

2. An edge-lit light box as defined in claim 1, further comprising a diffuser proximate the light source and configured to diffuse light across the non-opaque region.

3. An edge-lit light box as defined in claim 1, wherein the light source comprises a light emitting diode (LED).

4. An edge-lit light box as defined in claim 3, wherein the light source comprises a linear array of LEDs mounted to a printed circuit board that is attached to the light box frame.

5. An edge-lit light box as defined in claim 3, wherein the LED comprises an ultra bright LED.

6. An edge-lit light box as defined in claim 1, wherein the display screen comprises a transparent substrate having an opaque film formed thereon, the non-opaque region comprising a region on the substrate where the opaque film is absent.

7. An edge-lit light box as defined in claim 6, wherein the non-opaque region is an etched region in the opaque film.

8. An edge-lit light box as defined in claim 7, further comprising light catching micro etches in the transparent substrate corresponding with the etched region in the opaque film.

9. An edge-lit light box as defined in claim 7, wherein the non-opaque region is laser etched.

10. An edge-lit light box as defined in claim 1, wherein the backing comprises a light scattering surface selected to increase the amount of light projecting through the image area.

11. An edge-lit light box as defined in claim 10, wherein the backing is coated with a flat white paint on a surface thereof that faces the display member.

12. An edge-lit light box as defined in claim 1, wherein light box is less than about one inch thick.

13. An edge-lit light box as defined in claim 1, wherein the light box frame is less than about one quarter inch thick.

14. An edge-lit light box as defined in claim 1, further comprising an image connected to the backing on the inside of the light box such that it is at least partially visible through the non-opaque region of the display member.

15. An edge-lit light box as defined in claim 1, further comprising a display frame connected to the light box frame or display member such that the light box frame is not readily perceptible by a viewer.

16. An edge-lit light box, comprising:
a light box frame having opposing first and second sides and an inside surface;
an opaque backing connected to the first side of the frame;
a display substrate connected to the second side of the frame and opposite the backing such that a void is formed between the backing and the display substrate, the display substrate having an opaque film formed thereon with a laser etched image formed in the film such that a non-opaque image area is defined in the regions of the substrate where the opaque film is absent;
at least one LED connected to the interior surface of the light box frame such that operation of the LED emits into the void between the backing and the display screen; and
a diffuser proximate the light source and configured to diffuse light across the non-opaque region such that diffused and scattered light exits the light box through the image area such that a viewer can see a desired illuminated image at the image area.

17. An edge-lit light box as defined in claim 16, further comprising light scattering micro etches in the display substrate in the non-opaque image area.

18. An edge-lit light box as defined in claim 16, wherein the frame is less than about one quarter inch thick.

19. A method for forming an illuminated display, comprising:
providing a light box frame having opposing first and second sides and one or more inside surfaces;
attaching one or more light emitting diodes (LEDs) to the inside surface(s) of the frame;
attaching an opaque backing to the first side of the frame;
forming a display member by:
forming an opaque film on a transparent substrate; and
removing portions of the film to create a patterned image in the film; and
attaching the display member to the second side of the frame such that the light box frame, the backing and the display member define a void in the interior of the light box, at least some of the light emitted by the LEDs reaching the patterned image directly, by scattering, or through diffusion such that a user observing the illuminated display perceives an illuminated imaged defined by the patterned image.

20. A method as defined in claim 19, wherein the act of removing portions of the film comprises laser etching the image.
